(19) United States
(12) Patent Application Publication
(10) Pub. No.: US 2026/0030540 A1
(43) Pub. Date: Jan. 29, 2026

(54) NOISE-ROBUST FEDERATED LEARNING VIA OPTIMAL TRANSPORT

(71) Applicants: Mohammadhadi Amini, Miami, FL (US); Luiz Manella Pereira, Miami, FL (US)

(72) Inventors: Mohammadhadi Amini, Miami, FL (US); Luiz Manella Pereira, Miami, FL (US)

(73) Assignee: The Florida International University Board of Trustees, Miami, FL (US)

(21) Appl. No.: 18/781,474

(22) Filed: Jul. 23, 2024

(51) Int. Cl. G06N 20/00

(52) U.S. Cl. CPC G06N 20/00

(57) ABSTRACT

Systems and methods are provided for aggregating decentralized machine learning (ML) models in a resilient fashion in the presence of highly noisy data. The systems and methods focus on classification through the use of Wasserstein barycenters (WBs) and enable a geometry-preserving, noise-reducing approach based on optimal transport (OT). These can be used for many applications where there is a large amount of noise and is it desirable to minimize the impact of the noise on a decentralized ML model's performance.

### GOVERNMENT SUPPORT

This invention was made with government support under 23STSLA00016 awarded by the Department of Homeland Security, Science and Technology. The government has certain rights in the invention.

### BACKGROUND

Federated learning (FL) is a privacy-preserving, scalable, and computationally efficient decentralized machine learning approach. It enables privacy-centered learning to protect sensitive data (e.g., health-care data of patients or private information of drivers in transportation networks). A challenge while using FL algorithms for real-world problems is data heterogeneity, where edge devices are only exposed to a portion of data (referred to as local data), which tends to be only subsets of the global data spectrum.

### BRIEF SUMMARY

Embodiments of the subject invention provide novel and advantageous systems and methods for aggregating decentralized machine learning (ML) models in a resilient fashion in the presence of highly noisy data. The systems and methods focus on classification through the use of Wasserstein barycenters (WBs) and enable a geometry-preserving, noise-reducing approach. These can be used for many applications where there is a large amount of noise and is it advantageous (and/or a goal) to minimize the impact of the noise on an ML model's performance.

In an embodiment, a system for aggregating a decentralized ML model in a resilient fashion in the presence of highly noisy data can comprise: a processor; and a machine-readable medium in operable communication with the processor and having instructions stored thereon that, when executed by the processor, perform the following steps: creating local representations of each class on each edge device (e.g., by computing a local WB for each class on each edge device); collecting the local representations in a central server; combining the local representations at the central server to generate global representations; distributing the global representations from the central server to each edge device; and performing classification by computing a Wasserstein distance between a class representative and each respective data sample and choosing respective class labels based on a smallest Wasserstein distance for each class. The combining of the local representations to generate the global representations can comprise computing a respective global WB of the local WB of each class. The distributing of the global representations from the central server to each edge device can comprise distributing the respective global WB of each class. The steps can be performed as an optimal transport (OT)-based aggregation. The decentralized ML model can be, for example, a federated learning (FL) model. The instructions when executed can further perform the following step(s): using the global representations to train local models; and/or comparing the trained local models to global models. The creating of the local representations can comprise computing local moments and/or sending the local moments to the central server. The steps performed can be nonparametric. The decentralized ML model can be used for, e.g., anomaly detection, analysis of characters (e.g., letters or numbers), or analysis of objects (e.g., clothing items)). The local representations, the global representations, the local WB(s), the global WB(s), and/or the local moments can be stored on the central server, though the original data should not be stored on the central server (with the exception of the items mentioned). The system can further comprise a display in operable communication with the processor, the machine-readable medium, and/or the central server. The display can display results of the decentralized ML model and/or of any or all of the steps performed when the instructions are executed.

In another embodiment, a method for aggregating a decentralized ML model in a resilient fashion in the presence of highly noisy data can comprise: creating (e.g., by a processor) local representations of each class on each edge device (e.g., by computing a local WB for each class on each edge device); collecting (e.g., by the processor) the local representations in a central server; combining (e.g., by the processor) the local representations at the central server to generate global representations; distributing (e.g., by the processor) the global representations from the central server to each edge device; and performing (e.g., by the processor) classification by computing a Wasserstein distance between a class representative and each respective data sample and choosing respective class labels based on a smallest Wasserstein distance for each class. The combining of the local representations to generate the global representations can comprise computing a respective global WB of the local WB of each class. The distributing of the global representations from the central server to each edge device can comprise distributing the respective global WB of each class. The steps can be performed as an optimal transport (OT)-based aggregation. The decentralized ML model can be, for example, a federated learning (FL) model. The method can further comprise: using (e.g., by the processor) the global representations to train local models; and/or comparing (e.g., by the processor) the trained local models to global models. The creating of the local representations can comprise computing (e.g., by the processor) local moments and/or sending (e.g., by the processor) the local moments to the central server. The steps performed can be nonparametric. The decentralized ML model can be used for, e.g., anomaly detection, analysis of characters (e.g., letters or numbers), or analysis of objects (e.g., clothing items)). The local representations, the global representations, the local WB(s), the global WB(s), and/or the local moments can be stored on the central server, though the original data should not be stored on the central server (with the exception of the items mentioned). The method can further comprise a display in operable communication with the processor (and/or the central server), the machine-readable medium, and/or the central server. The display can display results of the decentralized ML model and/or of any or all of the steps performed.

### BRIEF DESCRIPTION OF DRAWINGS

FIG. 1 shows a federated learning architecture, according to an embodiment of the subject invention.

FIG. 2 shows a flow diagram of an algorithm, according to an embodiment of the subject invention.

FIG. 3 shows a simulation design, according to an embodiment of the subject invention.

FIG. 4 shows global Wasserstein barycenters (in the top row) and global traditional averaging barycenters (in the bottom row). This figure uses samples from the Modified National Institute of Standards and Technology (MNIST) dataset (see yann.lecun.com/exdb/mnist/; which is hereby incorporated by reference herein in its entirety).

FIG. 5 shows a close up of the first two columns of FIG. 4. The top row shows global Wasserstein barycenters, and the bottom row shows global traditional averaging barycenters. This figure uses samples from the MNIST dataset.

FIG. 6 shows a bar chart comparing accuracy score (in percentage (%)) for results of MNIST simulations. For each quantity of handwritten digits, the bar on the left is for Wasserstein barycenter, and the bar on the right is for traditional averaging.

FIG. 7 shows a bar chart comparing accuracy score (in percentage (%)) for results of Fashion MNIST (F-MNIST) simulations. For each garment/shoe/accessory type listed, the bar on the left is for Wasserstein barycenter, and the bar on the right is for traditional averaging.

FIG. 8 shows a table of features of related art systems and a system of an embodiment of the subject invention. The first row is for a system from Singh et al. (Model fusion via optimal transport, Advances in Neural Information Processing Systems 33, 2020, 22045-22055; which is hereby incorporated herein by reference in its entirety); the second row is for a system from McMahan et al. (Communication-efficient learning of deep networks from decentralized data, Artificial intelligence and statistics, PMLR, 2017, pp. 1273-1282; which is hereby incorporated herein by reference in its entirety); the third row is for a system from Li et al. (Abnormal client behavior detection in federated learning, arXiv preprint arXiv: 1910.09933, 2019; which is hereby incorporated herein by reference in its entirety); the fourth row is for a system from Ferrag et al. (Federated deep learning for cyber security in the internet of things: Concepts, applications, and experimental analysis, IEEE Access 9, 2021, 138509-138542; which is hereby incorporated herein by reference in its entirety); the fifth row is for a system from Ahmed et al. (A federated learning framework for automated decision making with microscopic traffic simulation, 2022 International Conference on Computer Communications and Networks (ICCCN), IEEE, 2022, pp. 1-9; which is hereby incorporated herein by reference in its entirety); the sixth row is for a system from Wang et al. (Federated learning for energy-efficient task computing in wireless networks, ICC 2020-2020 IEEE international conference on communications (ICC), IEEE, 2020, pp. 1-6; which is hereby incorporated herein by reference in its entirety); and the seventh row is for a system of an embodiment of the subject invention. In the table in FIG. 8, the heading “OT” stands for optimal transport, and the heading “FL” stands for federated learning. It can be seen that the system of an embodiment of the subject invention is the only one listed to have both OT and FL and be nonparametric.

FIG. 9 shows a table of simulation results for anomalies detected across devices and per distribution type.

FIG. 10 shows a table of accuracy score breakdown per handwritten digit and per model choice.

FIG. 11 shows a table of accuracy score breakdown per fashion class and per model choice.

FIG. 12 shows a table of the average accuracy of each nonparametric model for each dataset. In each of the MNIST and F-MNIST sections, the left column is the homogeneous data distribution scenario and the right column is the heterogeneous data distribution scenario. The “Acc. Loss” column displays the average accuracy loss between the homogeneous and heterogeneous scenarios. In the table, “kNN” represents a k-nearest neighbors algorithm, “GMM” represents a Gaussian mixture model, and “SVM” represents a support vector machine model, and “Our Model” represents a system of an embodiment of the subject invention.

FIG. 13 shows an algorithm for FL anomaly detection using Wasserstein barycenters, according to an embodiment of the subject invention.

FIG. 14 shows an algorithm for nonparametric classification via OT, according to an embodiment of the subject invention.

### DETAILED DESCRIPTION

Embodiments of the subject invention provide novel and advantageous systems and methods for aggregating decentralized machine learning (ML) models in a resilient fashion in the presence of highly noisy data. The systems and methods focus on classification through the use of Wasserstein barycenters and enable a geometry-preserving, noise-reducing approach. These can be used for many applications where there is a large amount of noise and is it advantageous (and/or a goal) to minimize the impact of the noise on an ML model's performance (e.g., a decentralized ML model's performance).

Federated learning (FL) is a solution to decentralized ML problems where data is kept private on edge devices. However, when there is highly noisy data, the performance of FL algorithms reduces significantly. Embodiments of the subject invention provide noise-robust algorithms and tools to tackle this problem with optimal transport (OT) and its tools by defining a global representation of each class that is being attempted to be predicted. This can be accomplished by first creating local representations of each class on each edge device, collecting these representations in a central server, and combining them to generate the global representations. After distributing them, classification can be performed by computing the Wasserstein distance of the sample with each class representative and choosing the label according to the smallest distance.

Embodiments of the subject invention demonstrate minimal accuracy loss under noisy inputs, including in a distributed network where the data at the edge can have minimal overlap in distribution. These properties were tested with known nonparametric models, and this approach yielded the best results (see also the Examples). This is accomplished due to the geometry-focused method that is an advantage over related art solutions.

Embodiments of the subject invention provide a resilient OT-based aggregation mechanism for federated machine learning. The systems and methods help real-world applications with noisy data to achieve higher performance as compared with related art tools and methods. This is accomplished by computing the Wasserstein barycenter (WB) for each class of data at the edge and distributing them to the central server, which then computes the WBs of the local WBs to generate global WBs, or global representations of each class of data. These global WBs can be broadcast back to each edge device, which then performs classification by selecting the data-WB pair of minimal distance with respect to the p-Wasserstein distance. The model is made noise-robust through the use of WBs as they are a robust method of averaging data.

A major challenge while using ML algorithms for real-world problems is data heterogeneity, where edge devices are only exposed to a portion of data (referred to as local data), which tends to be only subsets of the global data spectrum. Some methods to tackle this problem include data augmentation (e.g., rotation and blur) and domain generalization, the latter of which can separate an agent to be the “out-of-domain” test set while using the rest of the agents as the training set (i.e., the “in-domain” set). While both methods have some benefits over other methods, they indirectly tackle the problem. Therefore, there remains a gap in the attempt to effectively evaluate the performance of FL in terms of dealing with data heterogeneity or even preserving the privacy of the local users' data. Blockchain can be deployed in an attempt to provide a solution for the privacy challenges of FL.

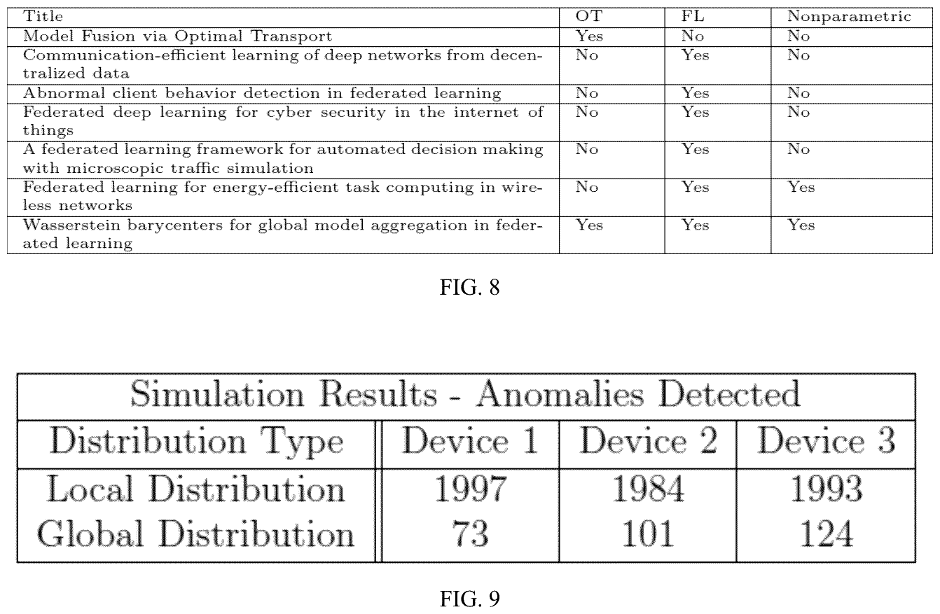

One major algorithm that is deployed in FL is referred to as federated averaging (parameter averaging), or FedAvg (see McMahan et al., supra.). It relies on arithmetic averaging, which is a simple method to aggregate local models and create a global learning model. There is a crucial need to develop more efficient aggregation mechanisms. Embodiments of the subject invention provide a novel approach that leverages WBs instead of arithmetic averaging. The table in FIG. 8 shows a comparison of features of related art systems and a system of an embodiment of the subject invention.

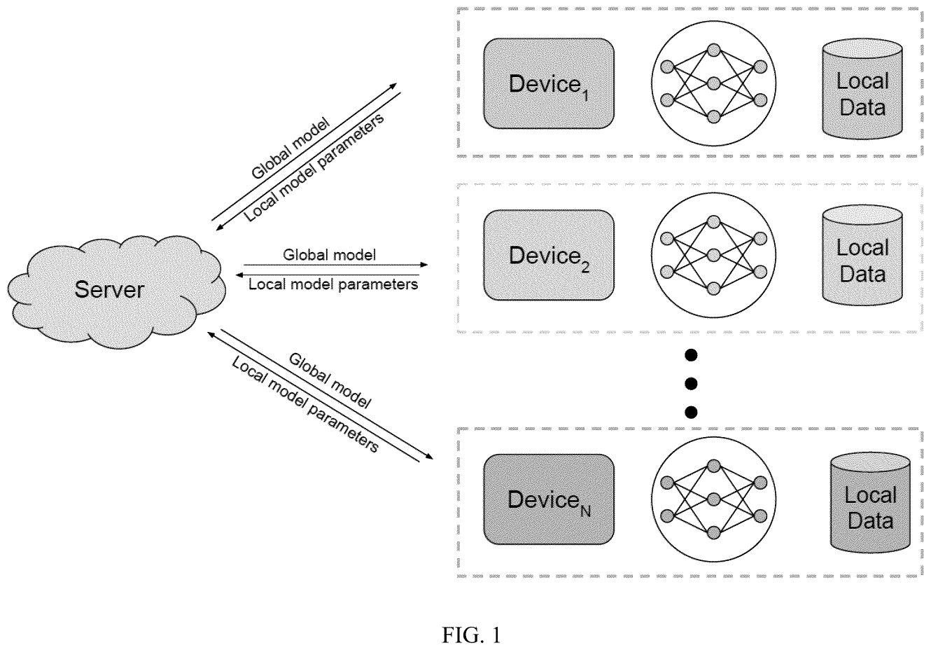

FL is a decentralized ML structure that generates a global model by learning from multiple decentralized edge clients (see also; Imteaj et al., A survey on federated learning for resource-constrained IoT devices, IEEE Internet of Things Journal 9 (1), 2021, 1-24; and Li et al., Federated learning: Challenges, Methods, and Future Directions, IEEE Signal Processing Magazine 37 (3), 2020, 50-60; both of which are hereby incorporated by reference herein in their entireties). As compared with the centralized ML structures that require data collection in the central server, FL relies on a different structure that does not require local agents to share their local dataset with the server, as shown in FIG. 1. In this structure, each local agent trains a local model based on its local dataset. They only share these models' parameters with the central server for global model aggregation. One of the challenges of FL is resource constraints at the edge devices; that is, edge devices may have low computing power, low bandwidth, and/or limited storage. Another challenge of FL is data heterogeneity. Data heterogeneity implies edge devices may only encounter bits and pieces of the global data, which may lead to high degrees of overfitting. The degree of unevenly distributed data across edge devices can significantly affect the final model accuracy and thus must be accounted for. A list of additional FL challenges can be found in Ti et al. (supra.) and Zhang et al. (A survey on federated learning, Knowledge-Based Systems 216, 2021, 106775; which is hereby incorporated by reference herein in its entirety). The ultimate goal of FL is to minimize the following objective function:

$${min}_{ω} F ( ω ) , \qquad ( 1 )$$

$$F ( ω ) = {\sum }_{k = 1}^{m} {p}_{k} {F}_{k} ( ω )$$

where m is the total number of devices, p≥0, Σₖ pₖ=1, and Fₖ is a local objective function of edge device k. Local objectives can be thought of as the empirical risk over the local data. One of the important use cases of FL is anomaly detection, which has several real-world applications, such as cybersecurity and the detection of abnormal client behavior in a decentralized setting. A toy example in anomaly detection contributed as part of the motivation for the utility of WBs in embodiments of the subject invention, and it can serve as a framework for comparison with other methods. For example, a pre-trained autoencoder can be used as an anomaly detection system, with further updating of the model by sharing the edge device's local model updates with the server as local training is performed on the data (see Liu et al., Abnormal client behavior detection in federated learning, arXiv preprint arXiv: 1910.09933, 2019; which is hereby incorporated by reference herein in its entirety). As the updates are shared in an unencrypted fashion, the privacy challenge is not considered in that proposed model. Each edge device makes a certain number of updates locally before sharing the parameters back to the central server until training is completed. The model in Liu et al. (supra.) relies on the FedAvg algorithm. The structure described from Liu et al. (supra.) is different from anomaly detection in embodiments of the subject invention, which can rely instead on purely statistical methods of independent identically distributed (i.i.d.) samples whose product forms a target distribution.

OT was originally tied directly to the problem of physically moving a pile of dirt from one location to its final placement (see also Monge, Memoire sur la theorie des deblais et des remblais, Mem. Math. Phys. Acad. Royale Sci., 1781, 666-704; which is hereby incorporated by reference herein in its entirety). The initial formulation of OT is as follows. Given a cost matrix (C_{i,j})_{i∈[[n]]j∈[[m]]}, where n=m, the optimal assignment problem seeks for a bijection σ in the set Perm(n) of permutation of n elements solving

$${min}_{σ ∈ Perm ( n )} \frac{1}{n} {\sum }_{i = 1}^{n} {C}_{i , σ ( i )}$$

The constraints can be softened by allowing for mass-splitting (see Kantorovich, On the transfer of masses: Doklady akademii nauk ussr, 1942; which is hereby incorporated by reference herein in its entirety). The problem can then be restated as follows. Given Monge Maps,

$$U ( a , b ) = \{ P ∈ {R}_{+}^{n \times m} : P {1}_{m} = a and {P}^{T} {1}_{n} = b \} ,$$

the OT problem can be written as:

$${L}_{C} ( a , b ) = {min}_{P ∈ U ( a , b )} 〈 C , P 〉 = {\sum }_{i , j} {C}_{i , j} {P}_{i , j}$$

where P represents a permutation matrix such that the products in U(.) recovers the original mass. From a statistical point of view, the key idea behind OT is to find an optimal mapping between two probability measures given the choice of different probability couplings between them. The following minimization problem can be solved (see also, Peyre et al., Computational optimal transport: With applications to data science, Foundations and Trends in Machine Learning 11 (5-6), 2019, 355-607; which is hereby incorporated by reference herein in its entirety),

$${ℒ}_{c} ( α , β ) = {min}_{( X , Y )} \{ {𝔼}_{( X , Y )} ( c ( X , Y ) ) : X ∼ α , Y ∼ β \} \qquad ( 2 )$$

where c(.) is a cost function and (X, Y) is a coupling of random variables over X×Y and X˜α means that the law of X, represented as a measure, must be α (similarly for Y˜β). The Kantorovich formulation leads to the definition of the Wasserstein distance between measures and the p-Wasserstein distance, as follows.

Proposition—Assume X=Y and that for some p≥1, c(x, y)=d(x, y)^{p}, where d is a distance on X

$$1. d ( x , y ) = d ( y , x ) \geq 0 ;$$

$$2. d ( x , y ) = 0 if and only if x = y ; and$$

$$3. ∀ ( x , y , z ) ∈ {X}^{3} , d ( x , z ) \leq d ( x , y ) + d ( y , z ) .$$

Then, the p-Wasserstein distance on X is,

$${W}_{p} ( α , β ) = {{ℒ}_{dp} ( α , β )}^{1 / p}$$

An alternative term for finding the mean value of a given dataset, which is commonly used in ML methods, is to compute the barycenter. The Wasserstein barycenter is computed as:

$${min}_{a ∈ {\sum }_{n}} {\sum }_{s = 1}^{S} {λ}_{8} {W}_{p}^{p} ( a , {b}_{s} ) \qquad ( 3 )$$

where a, b are probability vectors. To be more general, the barycenter problem can be written over arbitrary measures as such:

$${min}_{α ∈ {ℳ}_{+}^{1} ( 𝒳} {\sum }_{s = 1}^{S} {λ}_{8} {ℒ}_{c} ( α , {β}_{s} ) \qquad ( 4 )$$

given that (βₛ)ₛ is a measure defined over on a given space [symbol] = [symbol] ^{d} and c(x, y)=∥x−y∥². The weight hyperparameter, λₛ, can be modeled by uniform distribution for the sake of simplified notation (see also Cuturi et al., Fast computation of wasserstein barycenters, International conference on machine learning, PMLR, 2014, pp. 685-693; which is hereby incorporated by reference herein in its entirety). An important consequence of barycenters is that barycenters of datasets with Gaussian distribution result in a Gaussian distribution; this is equivalent to the concept of conjugate priors, where the choice of the conjugate prior should yield a target posterior distribution of the same form (see also; Agueh et al., Barycenters in the wasserstein space, SIAM Journal on Mathematical Analysis 43 (2), 2011, 904-924; and Bishop et al., Pattern recognition and machine learning, Vol. 4, Springer, 2006; both of which are hereby incorporated by reference herein in their entireties). Embodiments of the subject invention can include working with Gaussians, of which the inventors have a priori knowledge of the form of the posterior distribution.

Embodiments of the subject invention showcase the importance of choosing robust methods when generating global models in nonparametric FL. The geometry retention nature of OT brings forth this capability. To this end, Wasserstein barycenters can be leveraged to create a nonparametric classification algorithm. The reasoning for choosing OT can be motivated in part through a toy problem in anomaly detection. The performance of systems and methods of embodiments of the subject invention is showcased in computer vision by generating a global model to predict hand-written digits or fashion items, without the need to access the local data of distributed clients (see the Examples). The algorithm workflows used in the Examples can be generalized for deployment in other applications.

With respect to the aforementioned motivating toy problem in anomaly detection, the goal of anomaly detection is to compute the probability of an event given a set of input variables. In the toy problem, a probabilistic model can be used to define anomalies. Given some feature variable x, the p(x) can be computed as follows:

$$p ( x ) = {{\prod }_{i = 1}}^{N} p ( {x}_{i} \vert {μ}_{i} , {σ}_{i}^{2} ) \qquad ( 5 )$$

Assuming that the data follows a Gaussian distribution, we Equation 5 can be expanded to:

$$p ( x ) = {{\prod }_{i = 1}}^{N} \frac{1}{\sqrt{2 π} {σ}_{i}} exp ( - \frac{{( {x}_{i} - {μ}_{i} )}^{2}}{2 {σ}_{i}^{2}} ) \qquad ( 6 )$$

Anomaly detection is equivalent to choosing ϵ∈ [symbol] and checking if p(x)≤ϵ. Anomalies are data points that are not recognized as part of a known dataset. Thus, detecting an anomaly is equivalent to determining the probability of its occurrence; if the probability is sufficiently small, p(x)≤ϵ, then is it highly likely that it does not belong to a known dataset.

Given that this is a probabilistic model, this simplest approach is to generate a distribution over the dataset and proceed as previously described. While this is a reasonable approach, if the dataset is scattered across a network that cannot be accessed, then the user would be working with various distributions with different means and variances. Typically, one can average the distributions or use Gaussian mixture models (where reasonable). The problem with either of these approaches is the lack of geometry retention, in that they both yield a globalized distribution with a different modality than any of the input distributions. Wasserstein barycenter, on the other hand, is a geometry-retaining averaging methodology. If the inputs are unimodal, the average will also be unimodal. Following is a description of a FL setting where WBs are used to create the global distribution that is used to perform anomaly detection. This is a toy problem meant to demonstrate the importance of geometry and how to aggregate distributions, and is not a competing methodology to FL-based anomaly detection.

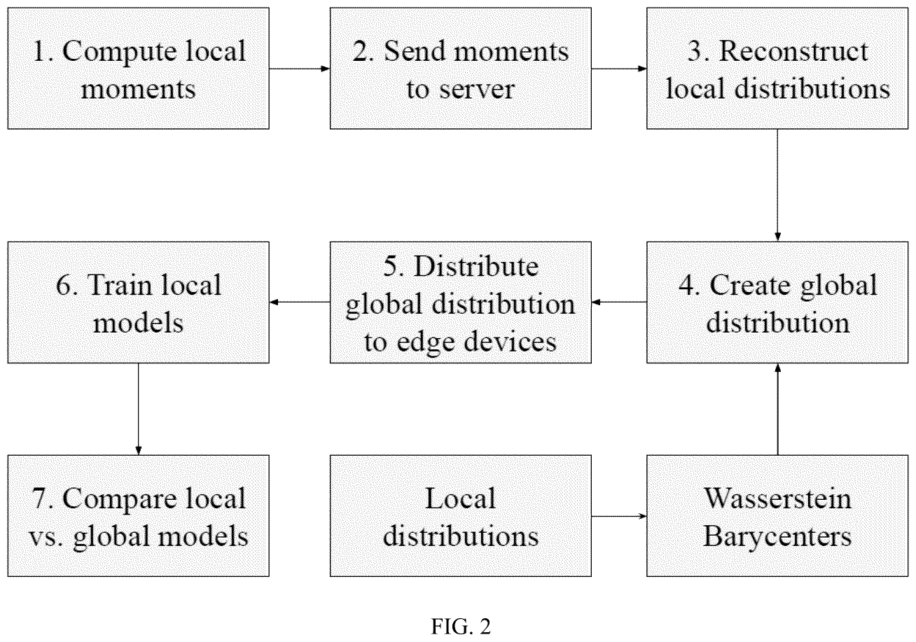

FIG. 2 shows a flow diagram of an algorithm that can be used in embodiments of the subject invention. Consider a network with D number of devices. Referring to FIG. 2, in Step 1, local distributions can be built given their data and the mean and variance can be computed for each edge device. Let i describe a device in the network and for each device i=1, . . . , D; the mean and variance can be computed as follows:

$${μ}_{i} = \frac{1}{N} {\sum }_{j = 1}^{n} {x}_{i}^{( j )} , \qquad ( 7 )$$

$${σ}_{i}^{2} = \frac{1}{N} {\sum }_{j = 1}^{N} {( {x}_{i}^{( j )} - {μ}_{i} )}^{2} .$$

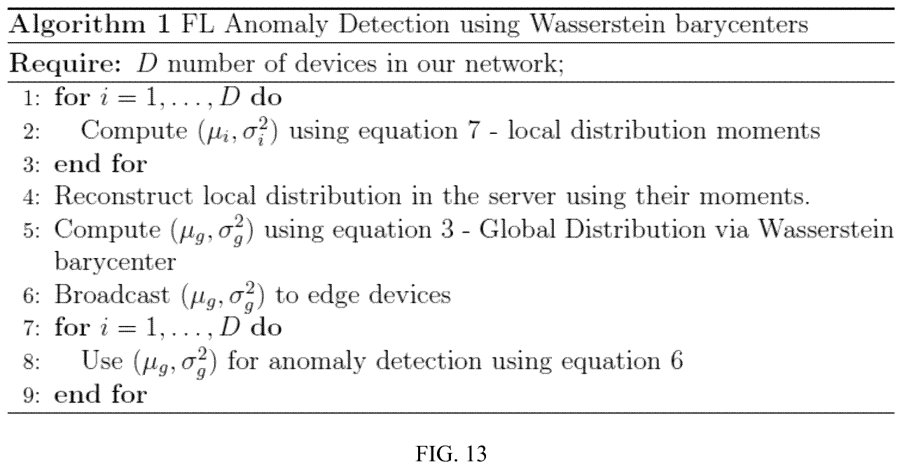

These two values can be broadcast to a central server in pairs (μᵢ, σᵢ²) (Step 2) to be used to reconstruct the local distributions (Step 3). In Step 4, a global distribution can be constructed through the barycenters explained in Equation 3. Once the global distribution is obtained, the pair (μ_{g}, σ_{g}²) containing the global mean and variance can be returned (Step 5). The global pair can be used by edge devices for anomaly detection (Step 6), and the results of these local simulations can be used in the final step for comparison. Algorithm 1, shown in FIG. 13, provides a step-by-step overview of this process. The results of the toy problem are discussed in Example 1.

A model was devised to predict handwritten digits from the Modified National Institute of Standards and Technology (MNIST) dataset and fashion items from the Fashion MNIST (F-MNIST) dataset using WBs given an FL structure. The classification method is computing the p-Wasserstein distance of some image to the set of WBs; the smallest distance becomes the class of the image. Examples 2 and 3 show the results, and the same experiment was repeated using the Euclidean norm as the distance function and the respective barycenter was generated using traditional arithmetic averaging. Traditional arithmetic averaging is as follows:

$$\overline{x} = \frac{1}{N} {\sum }_{i = 1}^{N} {x}_{i} \qquad ( 8 )$$

The results in Examples 2 and 3 include isolating the devised method according to an embodiment of the subject invention, which uses averaging as the classifier intentionally. This was done because it shows up in more complex approaches to solving the FL problem. For example, FedAvg is a common methodology to generate a singular, global, parametric model to perform inference along the edge devices. The approach of embodiments of the subject invention demonstrates how a nonparametric, OT-based approach leads to more robustness.

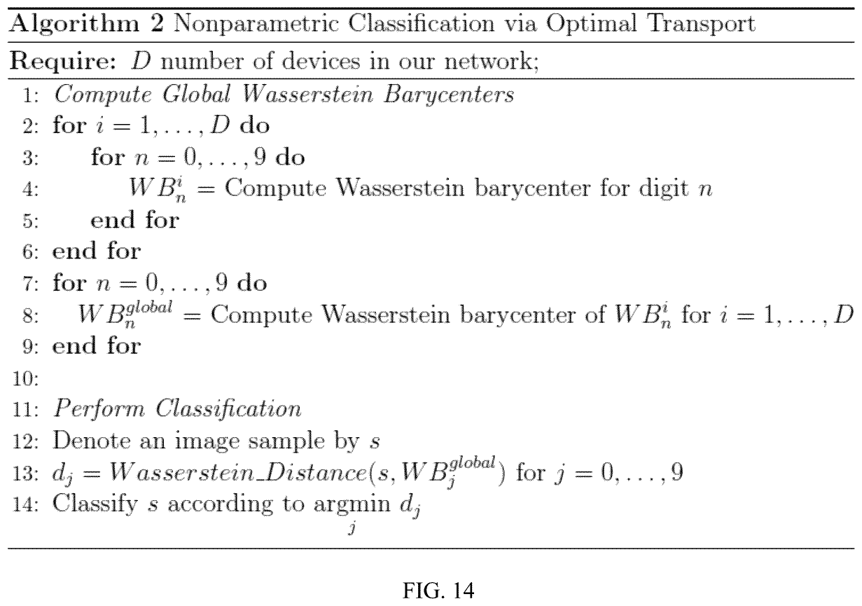

The data can be split into N devices and distributed to the devices, where each device can split its dataset into training and testing (e.g., 80%/20%, respectively). Separate simulations can be run for homogeneous and heterogeneous data distributions. The local devices can split their images, for example, based on class type. The local devices can then compute the local barycenters for their respective subset of images. Once they are done, the local devices can send to the central server their local barycenters, and the central server can then perform a global aggregation of barycenters to generate the global models. These global WBs can be broadcast back to the edge devices to perform inference on the test dataset. Classification can be made via the shortest distance to the global WBs. The distance function can be chosen based on the barycenter method; if the Wasserstein barycenter is chosen, the p-Wasserstein distance can be used, whereas when traditional averaging is chosen, the Euclidean distance can be used. The algorithm can be seen in Algorithm 2, shown in FIG. 14.

Embodiments of the subject invention address the data heterogeneity problem in FL. Three different applications were used to demonstrate the robustness-a toy problem in anomaly detection; WBs compared to Traditional Averaging in federated image classification; and several nonparametric models were compared with a model of an embodiment of the subject invention using homogeneous data and heterogeneous data distribution (see Examples 1-3). In Example 2, local barycenters were trained for each of the ten agents over their respective subsets of the MNIST and F-MNIST datasets. A central server triggers the aggregation process, which also uses WBs to generate global models; these models are redistributed to the agents to perform inference. The process was repeated using Traditional Averaging instead of WBs to have a point of comparison and to demonstrate how WBs are better at working with noise. The results in Example 2 show an average, per image, improvement in a range of from 9% to 28% for MNIST and in a range of from 15% to 25% for F-MNIST, with an overall average improvement of 19% for MNIST and 17% for F-MNIST. In addition to a higher accuracy than its averaging counterpart, the robustness of an OT-based approach to dataset imbalance and noise was demonstrated in Example 3. While some other nonparametric models yielded higher results, they were more largely impacted by the distribution of the data along the edge nodes.

Though the examples demonstrate the advantages of embodiments of the subject invention and are discussed in detail herein, these are only some of the many possibilities. The systems and methods of embodiments of the subject invention can be extended to many other fields. New fields, such as manifold reconstruction and information geometry, can be leveraged. Manifold reconstruction is used in reconstructing the data manifold from descriptive statistics, allowing transmission of data indirectly while having a lower dimensional representation that can be reconstructed in the central server. Information geometry allows performing of learning on manifolds, thereby extending the model types that can be considered within the framework of embodiments of the subject invention.

Manifold reconstruction can be thought of as an aggregator of multiple local distributions to create a global distribution. One can think of taking a puzzle, where all little pieces are symbolically local distributions but together make up a picture or a global distribution. The process of putting it together is known as manifold reconstruction. The process can be performed in O(n log n) time (see Cheng et al., Manifold reconstruction from point samples, SODA, Vol. 5, 2005, pp. 1018-1027; which is hereby incorporated by reference herein in its entirety). Manifold reconstruction relies strongly on computational topology and algebraic topology.

The algorithm first requires the definition for a(ϵ, δ)-sampling. Given a set S of points on manifold M, there is a sample p∈S such that ∥p−x∥≤ϵf(x) and samples p, q∈S such that ∥p−q∥≥δf(p). Further, assume that ϵ/δ is a constant; their pair make up the (ϵ, δ)-sampling.

Based on the algorithm for manifold reconstruction, the following input can be used to begin: a (ϵ, δ)-sampling from manifold M, and a sufficiently small ϵ. Next, the algorithm can construct Vor S and Del S, which are, respectively, a polyhedral complex and weighted Delaunay triangulation. The algorithm can then determine the dimension k of M “pumps up” the sample point weights to remove j-slivers from all point cocones and lastly can extract the cocone simplices as the resulting output. The final step can output Del_{M}S , which is homeomorphic to the original manifold M.

A distribution can be reconstructed solely from its moments, which is an extremely important task in practice and is a difficult one to solve. With the ability to reconstruct distributions from their moments, the transferring of sensitive information can be bypassed by only sharing the distribution's moments. The Gaussian constraint can facilitate a simulation because reconstructing unimodal Gaussians is straightforward (see also John et al., Thevenin, Techniques for the reconstruction of a distribution from a finite number of its moments, Chemical Engineering Science 62 (11), 2007, 2890-2904; which is hereby incorporated by reference herein in its entirety).

Distributions can be reconstructed via the parameter fitting method. To this end, it can be assumed that the general shape of the distribution is known onto which some curve fitting can be done using the moments from the known distribution. By using prior knowledge of the type of function being fitted (e.g., Gaussian), low-order moments can be used, computed using the standard method of moments (MOM), to obtain the parameters that will be used to fit the function (see also, Hulburt et al., Some problems in particle technology: A statistical mechanical formulation, Chemical engineering science 19 (8), 1964, 555-574; which is hereby incorporated by reference herein in its entirety). Although not limited to Gaussians, functions to be considered include half-normal, log-normal, β(beta), γ (gamma), exponential, Rayleigh, and Poisson. The mathematical details of these functions are explained elaborately in John et al. (supra.).

Inspired by the idea of using splines for function approximation, splines can be used to reconstruct distributions. Unlike the parameter fitting method, reconstruction by splines does not require a priori assumptions of the shape of the function, but alternatively approximates it using piecewise polynomials. First, consider an interval [a, b] such that during the reconstruction, if xᵢ<a or xᵢ>b, the approximated distribution vanishes identically, f(xᵢ)→0. With these conditions, one would simply perform spline approximation as is commonly done given the choice of spline (e.g., cubic spline) but introduce conditions based on the known moments of the underlying distribution. Consider a cubic spline such that the kth moment of the spline s⁽³⁾ must also be considered, for k∈ [symbol] ,

$${\int }_{{x}_{1}}^{{x}_{n + 1}} {x}^{k} {s}^{( 3 )} ( x ) dx = {\sum }_{i = 1}^{n} {\sum }_{j = 0}^{3} {s}_{ij} {\int }_{{x}_{i}}^{{x}_{i + 1}} {{x}^{k} ( x - {x}_{i} )}^{j} dx$$

This expression must be the same as the kth moment μₖ of f, for k=0, 1, . . . .

Other boundary conditions exist to affect strictly the first and last intervals of the spline but are not related to the moments of the distribution, which is solely controlled by the equation above.

The noise-robust FL models of embodiments of the subject invention can benefit a wide range of applications, including but not limited to: demand side management in energy and power systems in presence of highly noisy weather-related data; automated audio analysis in the presence of environmental noise while preserving privacy of users; image recognition in the presence of highly noisy data; automated fire-fighter robots that need to deal with highly noisy environments when performing in the affected environment; and rescue robots that need to explore highly noisy images and videos of affected areas (e.g., earthquake affected area) and make decisions.

Embodiments of the subject invention provide a focused technical solution to the focused technical problem of FL algorithms having significantly reduced performance when there is noisy data. The solution is provided by using OT and WBs, which results in minimal accuracy loss or efficiency loss under noisy inputs, including in a distributed network where the data at the edge can have minimal overlap in distribution. Embodiments of the subject invention can improve the computer system performing the FL-based algorithm by showing decreased efficiency loss compared to related art FL-based algorithms (this can free up memory and/or processor usage).

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1—Toy Problem in Anomaly Detection

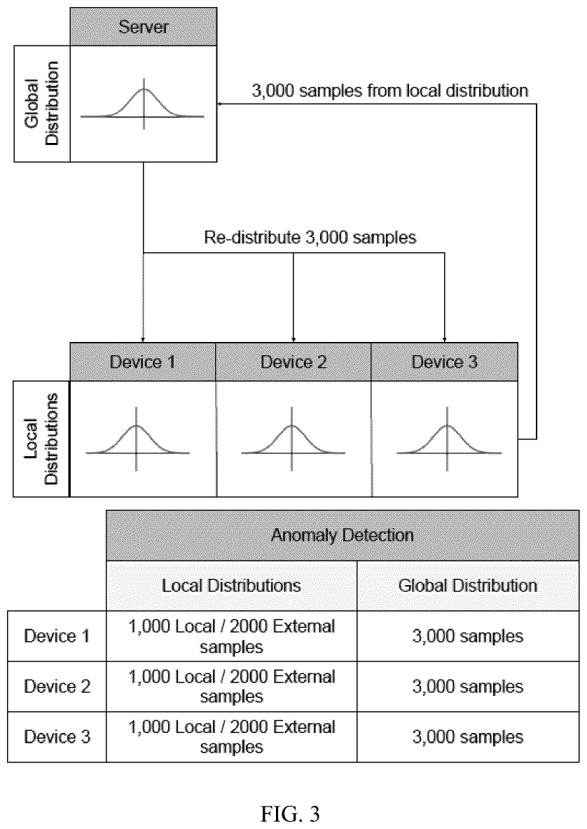

Simulations were designed to compare the effectiveness of each edge device in detecting whether the received data is from a known distribution or if it is anomalous. In the simulation design, anomalous data refers to data that is from an unknown distribution. FIG. 3 represents an overview of the simulation architecture.

Referring to FIG. 3, simulations include three different distributions with the same variance and different mean values. The mean should be chosen such that the distributions are far enough apart that the overlap is minimal or non-existent. One thousand (1,000) samples were generated from each agent's local distribution to make a dataset of 3,000 different sample points. These sample points were then broadcast to each edge device to test for anomalous data using their respective local and global distribution. An ϵ=0.001, also known as the probability decision boundary, was used during the classification process. The outcome was stored as the number of edge devices that are identified as anomalous. The goal is to compare how the local probability distributions classify points as anomalies in comparison to the global probability distribution. The global probability distribution may have zero (0) classifications as anomalous because it is an aggregate of all three distributions.

After running the simulation, the local distributions flagged between 1,993 and 1,997 points to be anomalies. These points were those that were sampled from the other two distributions. On the other hand, when passing the 3,000 points to the global distribution, that were originally passed to each edge device, on average only 3-5% of the points were flagged as anomalous. The simulation results verify the hypothesis. By creating a global distribution that contains information over all other distributions, the edge devices were able to be exposed to a model that contains much more information than what it was exposed to. The table in FIG. 9 shows a visual summary of these results.

### Example 2—FL MNIST and F-MNIST with WB

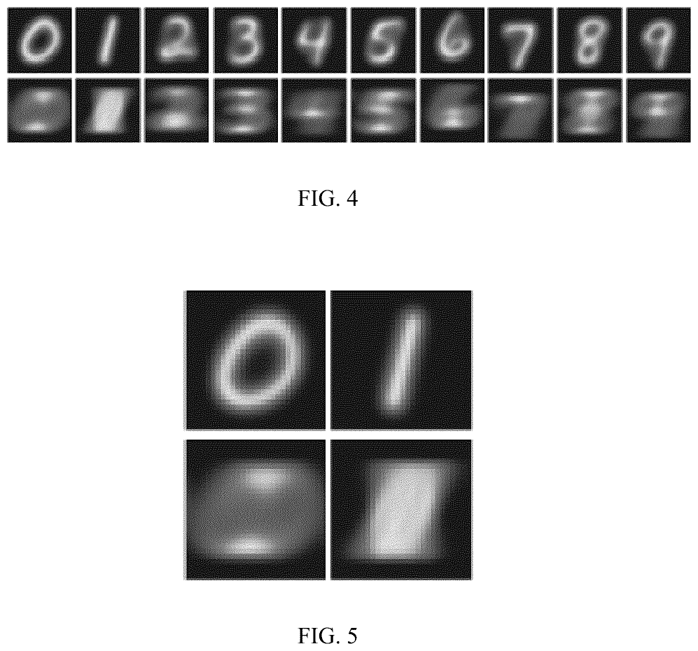

By following Algorithm 2 (FIG. 14), an accuracy score for both methods (i.e., using WB and using Traditional Averaging) was generated in order to compare them. More importantly, some translation noise was also introduced into the images due to their extreme preprocessing, rendering them almost too unrealistic. It is seldom the case where data is perfectly aligned in the center of the space across thousands of samples. In order to render the simulation more realistic, and to showcase how WBs handle noise with much better precision (see FIG. 4), some images were randomly shifted left or right a maximum of seven pixels. Further, in order to speed up the generation of local models, the WB generation was multi-threaded across each agent so that they may train independently of the other. Steps in Algorithm 2 were triggered by the central server, which acts as a scheduler (or coordinator). The server itself can multi-thread the creation of the global models, allowing the WB for each class to be created at their own pace, at the same time. Once a pass was made through the algorithm and an accuracy score was generated for the Wasserstein barycenter model, it was repeated for the Traditional Averaging choice such that results could be generated for comparison.

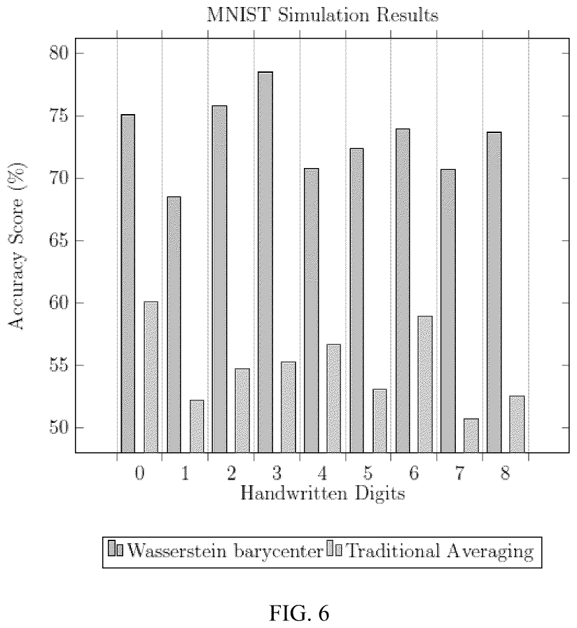

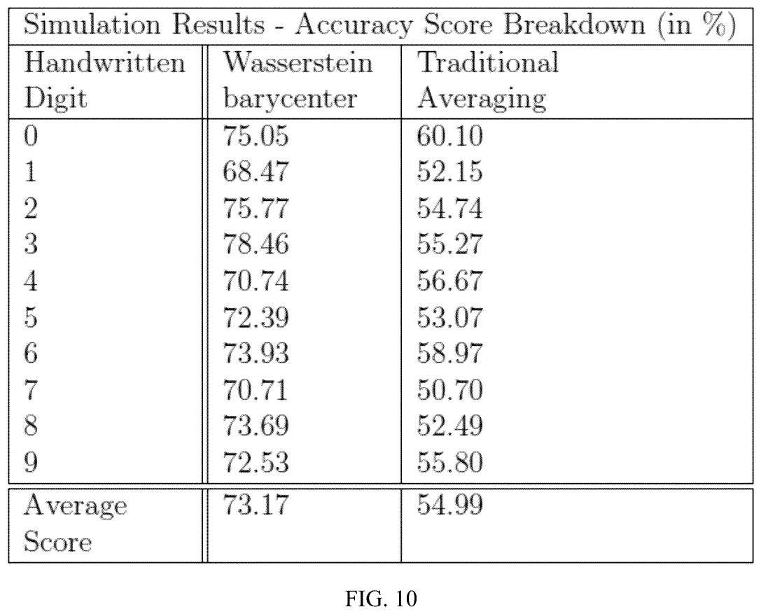

Results were obtained for both datasets under a homogeneous framework. Results were also obtained against various other nonparametric models given the same federated architecture. Due to the inherent ability of Wasserstein-based methods to overcome noise-induced difficulties (such as translation) by focusing on the geometry of the object, the results were advantageous. Referring to FIGS. 4 and 5, noise introduces a problem during classification. Traditional Averaging is incapable of seeing beyond where mass lies and must always attribute mass to locations where it exists while performing averaging. Wasserstein barycenter on the other hand focuses on the geometry of the object, allowing it to move mass around to fit an average over the objects such that geometry retention is maximized. Because of this property, the average accuracy score using WB across the classification of all handwritten digits was 73.17%, while for Traditional Averaging it was 54.99%. The table in FIG. 10 shows the predictions of each model type and each handwritten digit, and the comparison in bar chart form is shown in FIG. 6.

Although 73% is relatively low, the method itself was relatively naïve for this example. Images were intelligently averaged, in an attempt to capture the geometry, and a distance function that also is geometry-focused was used. Therefore, given the simplicity of the idea, the results yielded are relatively good. Two points to notice are that predictions for ones and sevens are on the lower end of the spectrum. It is believed that the variations in how people write the number one, which is similar to sevens at times, caused the lowering of the accuracy. Digits that have little variation in drawing, such as zero and three, had higher scores.

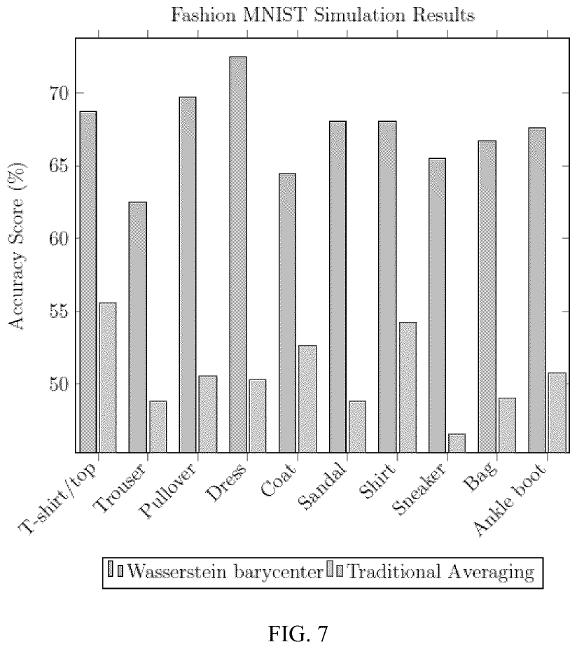

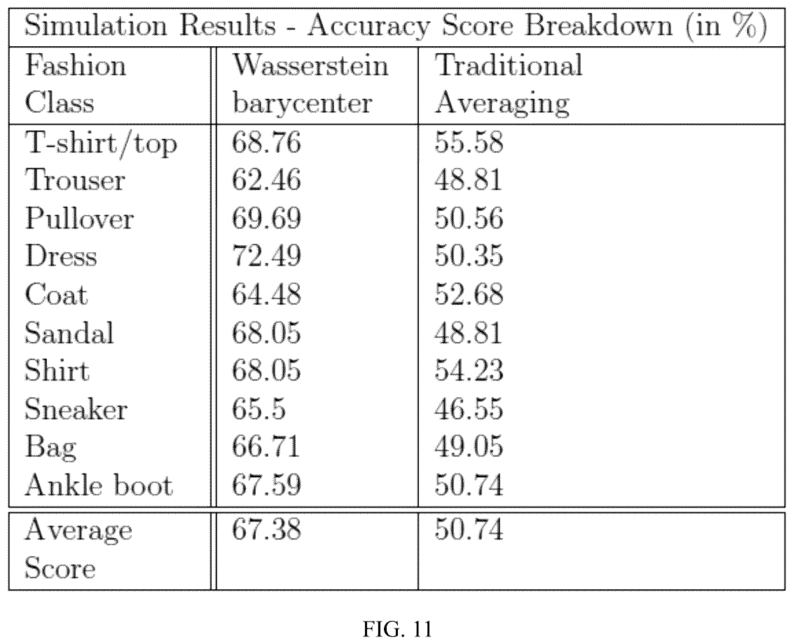

Similarly to MNIST, it was hypothesized that WB-based modeling would yield better results for F-MNIST. The accuracy of the results were expected to be lower (compared to the MNIST simulation results) for both model choices because the underlying data contains more details in the same 28-by-28 pixel space. Although there are more details, they cannot be captured very well because the low number of pixels renders the images too low quality to easily distinguish differences when using relatively naive models. Nonetheless, it can be seen in FIG. 7 that the WB-based model had higher accuracy than traditional parameter averaging across all fashion classes. More detailed values are shown in the table in FIG. 11.

On average, the model with WBs achieved a 67.38% accuracy while Traditional Averaging achieved 50.74%. For each class, on average, an accuracy improvement was noticed between 15-25%. Although the difference between the average accuracy between both models for F-MNIST was 2% less than that in MNIST, the range of improvement on a per-class basis was higher, further demonstrating the superiority of the model of an embodiment of the subject invention on a more complex dataset.

### Example 3—Nonparametric Models Using Homogeneous Data and Heterogeneous Data Distribution

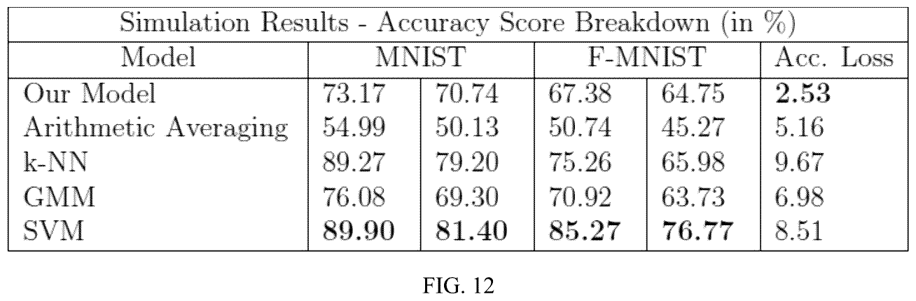

While the MNIST and F-MNIST testing in Example 2 was strictly in a homogeneous setting, testing was also performed (on MNIST and F-MNIST datasets) to compare results in a heterogeneous data distribution setting and display results of other nonparametric models (arithmetic averaging, k-NN, GMM, and SVM) across both data distribution domains. The table in FIG. 12 demonstrates the results concisely. The goal was to showcase the robustness of the approach of embodiments of the subject invention not only to noise but also to the data heterogeneity problem. It is important to note a few details when comparing these models. For example, choosing k-NN implies only local models can be used, and in turn, the model cannot have any exposure to data from other distributions; for this reason, the difference in accuracy between the two data distribution domains is expected to be highest. Further, the model of an embodiment of the subject invention is a simple model in comparison to some of the other models, such as SVM. While SVM may yield higher accuracy than the model of an embodiment of the subject invention, it was affected more than the subject model when changing from a homogeneous data distribution to a heterogeneous one; this difference in accuracy is displayed as the last column in the table in FIG. 12. While the realistically simple approach of the model of an embodiment of the subject invention did not yield the highest result, it was the most robust, with an average accuracy loss of only 2.53% across both datasets when changing the data distribution setting.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

1. A system for aggregating a decentralized machine learning (ML) model in a resilient fashion in the presence of highly noisy data, the system comprising:
a computing device;
a processor disposed in the computing device; and
a machine-readable medium disposed in the computing device, in operable communication with the processor, and having instructions stored thereon that, when executed by the processor, perform the following steps:
a) creating local representations of each class on each edge device by computing a local Wasserstein barycenter (WB) for each class on each edge device, the local WB being a minimizer of a function over multiple distributions;
b) collecting the local representations in a central server;
c) combining the local representations at the central server to generate global representations;
d) distributing the global representations from the central server to each edge device;
e) performing classification by computing a Wasserstein distance between a class representative and each respective data sample and choosing respective class labels based on a smallest Wasserstein distance for each class, thereby aggregating the decentralized ML model to give an aggregated decentralized ML model; and
f) detecting anomalies, utilizing the aggregate decentralized ML model, in at least one of a cybersecurity setting and client behavior in a decentralized setting; and
g) blocking future traffic from any sources of anomalies detected in step D), thereby improving security of the computing device.

2. The system according to claim 1, the combining of the local representations to generate the global representations comprising computing a respective global WB of the local WB of each class.

3. The system according to claim 2, the distributing of the global representations from the central server to each edge device comprising distributing the respective global WB of each class.

4. The system according to claim 1, steps a)-e) being performed as an optimal transport (OT)-based aggregation.

5. The system according to claim 1, the decentralized ML model being a federated learning (FL) model.

6. The system according to claim 1, the instructions when executed further performing the following step:
h) using the global representations to train local models.

7. The system according to claim 6, the instructions when executed further performing the following step:
i) comparing the trained local models to global models.

8. The system according to claim 1, the creating of the local representations comprising computing local moments.

9. The system according to claim 1, the performing of steps a)-e) being nonparametric.

10. The system according to claim 1, the instructions when executed further performing the following step:
j) performing at least one of the following:
j-1) controlling a power system to maintain voltage output in presence of highly noisy weather-related data, the decentralized ML model being used to maintain the voltage output of the power system, and steps a)-e) aggregating the decentralized ML model in the presence of the highly noisy weather-related data;
j-2) controlling automated audio analysis in presence of environmental noise while preserving privacy of users, the decentralized ML model being used for the automated audio analysis, and steps a)-e) aggregating the decentralized ML model in the presence of the environmental noise;
j-3) controlling image recognition in presence of highly noisy data, the decentralized ML model being used for the image recognition, and steps a)-e) aggregating the decentralized ML model in the presence of the highly noisy data;
j-4) controlling an automated fire-fighter robot to operate normally in a highly noisy environment, the decentralized ML model being used to automate the fire-fighter robot, and steps a)-e) aggregating the decentralized ML model in the presence of the highly noisy environment; and
j-5) controlling a rescue robot to explore highly noisy images and videos of an affected disaster area and make a rescue decision, the decentralized ML model being used to explore with the rescue robot, and steps a)-e) aggregating the decentralized ML model in the presence of the highly noisy images and videos the performing of steps a)-e) improving the computing device by freeing up memory and processor usage on the computing device via decreased efficiency loss on the computing device.

11. A method for aggregating a decentralized machine learning (ML) model in a resilient fashion in the presence of highly noisy data, the method comprising:
a) creating local representations of each class on each edge device by computing a local Wasserstein barycenter (WB) for each class on each edge device, the local WB being a minimizer of a function over multiple distributions;
b) collecting the local representations in a central server;
c) combining the local representations at the central server to generate global representations;
d) distributing the global representations from the central server to each edge device; and
e) performing classification by computing a Wasserstein distance between a class representative and each respective data sample and choosing respective class labels based on a smallest Wasserstein distance for each class, thereby aggregating the decentralized ML model to give an aggregated decentralized ML model; and
f) detecting anomalies, utilizing the aggregate decentralized ML model, in at least one of a cybersecurity setting and client behavior in a decentralized setting; and
g) blocking future traffic from any sources of anomalies detected in step f), thereby improving security of a computing device on which the method is performed.

12. The method according to claim 11, the combining of the local representations to generate the global representations comprising computing a respective global WB of the local WB of each class.

13. The method according to claim 12, the distributing of the global representations from the central server to each edge device comprising distributing the respective global WB of each class.

14. The method according to claim 11, steps a)-e) being performed as an optimal transport (OT)-based aggregation.

15. The method according to claim 11, the decentralized ML model being a federated learning (FL) model.

16. The method according to claim 11, further comprising:
h) using the global representations to train local models.

17. The method according to claim 16, further comprising:
i) comparing the trained local models to global models.

18. The method according to claim 11, the creating of the local representations comprising computing local moments, and
the performing of steps a)-e) being nonparametric.

19. The method according to claim 11, further comprising:
j) performing at least one of the following:
j-1) controlling a power system to maintain voltage output in presence of highly noisy weather-related data, the decentralized ML model being used to maintain the voltage output of the power system and steps a)-e) aggregating the decentralized ML model in the presence of the highly noisy weather-related data;
j-2) controlling automated audio analysis in presence of environmental noise while preserving privacy of users, the decentralized ML model being used for the automated audio analysis, and steps a)-e) aggregating the decentralized ML model in the presence of the environmental noise;
j-3) controlling image recognition in presence of highly noisy data, the decentralized ML model being used for the image recognition, and steps a)-e) aggregating the decentralized ML model in the presence of the highly noisy data;
j-4) controlling an automated fire-fighter robot to operate normally in a highly noisy environment, the decentralized ML model being used to automate the fire-fighter robot, and steps a)-e) aggregating the decentralized ML model in the presence of the highly noisy environment; and
j-5) controlling a rescue robot to explore highly noisy images and videos of an affected disaster area and make a rescue decision, the decentralized ML model being used to explore with the rescue robot, and steps a)-e) aggregating the decentralized ML model in the presence of the highly noisy images and videos.

20. A system for aggregating a decentralized machine learning (ML) model in a resilient fashion in the presence of highly noisy data, the system comprising:
a computing device;
a processor disposed in the computing device; and
a machine-readable medium disposed in the computing device, in operable communication with the processor, and having instructions stored thereon that, when executed by the processor, perform the following steps:
a) creating local representations of each class on each edge device by computing a local Wasserstein barycenter (WB) for each class on each edge device, the local WB being a minimizer of a function over multiple distributions;
b) collecting the local representations in a central server;
c) combining the local representations at the central server to generate global representations;
d) distributing the global representations from the central server to each edge device;
e) performing classification by computing a Wasserstein distance between a class representative and each respective data sample and choosing respective class labels based on a smallest Wasserstein distance for each class, thereby aggregating the decentralized ML model to give an aggregated decentralized ML model;
f) using the global representations to train local models;
g) comparing the trained local models to global models; and
h) detecting anomalies utilizing the aggregate decentralized ML model, in at least one of a cybersecurity setting and client behavior in a decentralized setting;
i) blocking future traffic from any sources of anomalies detected in step h), thereby improving security of the computing device; and
j) performing at least one of the following:
j-1) controlling a power system to maintain voltage output in presence of highly noisy weather-related data, the decentralized ML model being used to maintain the voltage output of the power system, and steps a)-e) aggregating the decentralized ML model in the presence of the highly noisy weather-related data;
j-2) controlling automated audio analysis in presence of environmental noise while preserving privacy of users, the decentralized ML model being used for the automated audio analysis, and steps a)-e) aggregating the decentralized ML model in the presence of the environmental noise;
j-3) controlling image recognition in presence of highly noisy data, the decentralized ML model being used for the image recognition, and steps a)-e) aggregating the decentralized ML model in the presence of the highly noisy data;
j-4) controlling an automated fire-fighter robot to operate normally in a highly noisy environment, the decentralized ML model being used to automate the fire-fighter robot, and steps a)-e) aggregating the decentralized ML model in the presence of the highly noisy environment; and
j-5) controlling a rescue robot to explore highly noisy images and videos of an affected disaster area and make a rescue decision, the decentralized ML model being used to explore with the rescue robot, and steps a)-e) aggregating the decentralized ML model in the presence of the highly noisy images and videos,
the combining of the local representations to generate the global representations comprising computing a respective global WB of the local WB of each class,
the distributing of the global representations from the central server to each edge device comprising distributing the respective global WB of each class,
steps a)-g) being performed as an optimal transport (OT)-based aggregation,
the decentralized ML model being a federated learning (FL) model,
the creating of the local representations comprising computing local moments,
the performing of steps a)-g) being nonparametric, and
the performing of steps a)-e) improving the computing device by freeing up memory and processor usage on the computing device via decreased efficiency loss on the computing device.
